(19) United States
(12) Patent Application Publication
(10) Pub. No.: US 2026/0147533 A1
(43) Pub. Date: May 28, 2026

(54) APPARATUS FOR CONTROLLING OUTPUT OF AUDIO DATA INCLUDING BINAURAL BITS AND METHOD THEREFOR

(71) Applicant: LG ELECTRONICS INC., Seoul (KR)

(72) Inventors: Myungjin OH, Seoul (KR); Sangjun PARK, Seoul (KR); Seungyong LEE, Seoul (KR); Donghoon LEE, Seoul (KR); Gyeongil BAEK, Seoul (KR)

(73) Assignee: LG ELECTRONICS INC., Seoul (KR)

(21) Appl. No.: 19/231,768

(22) Filed: Jun. 9, 2025

(30) Foreign Application Priority Data
Nov. 28, 2024 (WO) PCT/KR2024/019083

(51) Int. Cl. G06F 3/16; H04S 1/00

(52) U.S. Cl. CPC G06F 3/165; H04S 1/007

(57) ABSTRACT

Disclosed is an apparatus for outputting audio data including a binaural bit, the apparatus including an information collector configured to obtain user information and a processor configured to control an output of audio data including a binaural bit, wherein the processor may be further configured to determine a volume level of an audio output of the binaural bit according to the user information obtained at a first timing point and output the audio data including the binaural bit according to the volume level determined at the first timing point and wherein the processor may be further configured to determine the volume level of the audio output of the binaural bit according to the user information obtained while the audio data is being outputted at a second timing point and output the audio data including the binaural bit according to the volume level determined at the second timing point.

Pursuant to 35 U.S.C. § 119(a), this application claims the benefit of earlier filing date and right of priority to International Application No. PCT/KR2024/019083, filed on Nov. 28, 2024, the contents of which are hereby incorporated by reference herein in their entirety.

### BACKGROUND OF THE DISCLOSURE

### Field of the Disclosure

The present disclosure relates to an apparatus for controlling an output of audio data including binaural bits and method therefor, and more specifically, to an apparatus configured to control a volume of audio data including binaural bits based on user information and method therefor.

### Discussion of the Related Art

A binaural bit sound source or audio based on user information or biometric signals refers to an audio experience provided in a manner of being customized according to user data collected in real time. A binaural bit is a scientific method of artificially generating brain waves by sending different frequency signals to both ears, and is mainly used for concentration improvement, stress reduction, and meditation. Here, when a technology based on a user's biometric signal (heart rate, brain waves, breathing pattern, etc.) or behavioral data (sleep habit, fatigue, etc.) is combined, a binaural bit sound source customized to an individual's current state may be generated.

The following are an operating method and major features of such a system.

### Biometric Signal Measurement

Biometric signals such as heart rate, brain waves, respiratory rate, stress index, skin temperature and the like are measured by a wearable device (e.g., smart watch, EEG headset, etc.) to reflect a real-time state of a user. Accordingly, whether the user needs to concentrate, relax, or induce sleep may be obtained.

### Signal Analysis and Audio Adjustment

Biometric signal data are analyzed to set a binaural bit frequency suitable for a user's state. For example, if a user is under stress, a binaural bit of a delta or theta wave region that induces relaxation is reproduced. If concentration is required, it is adjusted into a frequency of an alpha wave region.

### Customized Sound Source Generation and Feedback

An initially set frequency is automatically fine-tuned according to a user signal. And, when a user reaches a specific state, a sound source is adjusted in real time according to a signal change through a feedback loop. For example, when a heart rate drops or brain waves are converted to a relaxed state, an audio tone is naturally adjusted.

### Learning and Improving Personalization

A system may learn user's reaction to provide a more precise and customized sound source in the long term. By learning user's brainwave or heart rate pattern using a machine learning algorithm, a sound source may be adjusted to obtain a better effect over time.

Such a personalized binaural beat system is useful for meditation, concentration, sleep induction, etc., and may greatly aid in psychological stability, stress relief, and productivity improvement.

However, since conventional studies focused only on the creation of binaural bit sound sources based on biometric signals, the effect of binaural bit volume was overlooked on a personalized basis, and it takes a lot of time to measure and analyze changes in biometric signals in real time while listening to binaural bit sound sources to find customized volume for users.

Accordingly, the present disclosure intends to propose an efficient method for changing a user's brainwave state by outputting a binaural bit sound source or audio.

### SUMMARY OF THE DISCLOSURE

One object of the present disclosure is to propose an efficient method for changing a user's brainwave state by outputting a binaural bit sound source or audio.

In one technical aspect of the present disclosure, proposed is an apparatus configured to output audio data including a binaural bit, the apparatus including an information collector configured to obtain user information and a processor configured to control an output of audio data including a binaural bit, wherein the processor may be further configured to determine a volume level of an audio output of the binaural bit according to the user information obtained at a first timing point and output the audio data including the binaural bit according to the volume level determined at the first timing point and wherein the processor may be further configured to determine the volume level of the audio output of the binaural bit according to the user information obtained while the audio data is being outputted at a second timing point and output the audio data including the binaural bit according to the volume level determined at the second timing point.

Additionally or alternatively, in response to that the user information obtained at the second timing point fails to fall within a preset range, the processor may be configured to set the volume level of the audio output of the binaural bit to a preset value.

Additionally or alternatively, in response to that the user information obtained at the second timing point falls within a preset range, the processor may be configured to maintain the volume level of the audio output of the binaural bit.

Additionally or alternatively, the processor may be configured to output the audio data including the binaural bit for a plurality of users based on user information of a plurality of the users and the volume level of the audio output of the binaural bit for each of a plurality of the users or a variable range of the volume level may be set independently or individually.

Additionally or alternatively, the audio data may include background audio data.

Additionally or alternatively, the volume level of the binaural bit may be set smaller than that of the background audio data.

Additionally or alternatively, the user information may include biometric information of a user.

Additionally or alternatively, the volume level of the audio output of the binaural bit may be configured to have a variable range set according to a range among a plurality of preset ranges, to which the user information belongs.

Additionally or alternatively, the first timing point may be set to a timing point before a request for the audio output of the binaural bit based on the user information of a user is inputted.

Additionally or alternatively, an interval between the first timing point and the second timing point may be set according to the user information obtained at the first timing point.

In another technical aspect of the present disclosure, provided is a method for outputting audio data including a binaural bit by a device configured to control an output of the audio data including the binaural bit. The method may include determining a volume level of an audio output of the binaural bit according to user information obtained at a first timing point, outputting the audio data including the binaural bit according to the volume level determined at a first timing point, determine the volume level of the audio output of the binaural bit according to the user information obtained while the audio data is being outputted at a second timing point, and outputting the audio data including the binaural bit according to the volume level determined at the second timing point and

In further technical aspect of the present disclosure, provided is a computer-readable medium for storing a code configured to execute the method for outputting audio data including a binaural bit by a computer or a processor.

The above objects are only some of the embodiments of the present disclosure, and various embodiments reflecting the technical features of the present disclosure may be derived and understood by those skilled in the art based on the detailed description of the present disclosure described below.

The present disclosure has the following technical effects.

In the present specification, a binaural bit sound source means a sound source including a binaural bit.

According to the present disclosure, an initial volume of a binaural bit sound source may be set based on user information obtained, so that the purpose of the binaural bit sound source (sleep, stress relief, concentration, etc.) may be achieved in a relatively short time.

In addition, the present disclosure may reset a volume of a binaural bit sound source based on user information obtained to achieve the purpose of the binaural bit sound source (sleep, stress relief concentration, etc.) in a relatively short time.

The effects of the present disclosure are not limited to the above-mentioned effects, and other effects not mentioned will be clearly understood by those skilled in the art to which the present disclosure pertains from the detailed description of the present disclosure below.

### BRIEF DESCRIPTION OF THE DRAWINGS

The accompanying drawings, which are included as part of the detailed description to help understanding of the present disclosure, provide an embodiment of the present disclosure and describe the technical idea of the present disclosure with the detailed description.

FIG. 1 is a diagram illustrating a protocol of an experiment performed to obtain an important factor for controlling an output of a binaural bit sound source according to the present disclosure.

FIG. 2 a diagram illustrating the distribution of Root Mean Square of Successive Differences (RMSSD) values of subject's Heart Rate Variability (HRV) according to a volume of a binaural bit sound source, obtained experimentally.

FIG. 3 a diagram illustrating the distribution of subject's Heart Rate Variability (HRV) of Logarism of High-Frequency Power (lnHF) value according to a volume of a binaural bit sound source, obtained experimentally.

FIG. 4 is a flowchart of a method for controlling an output volume of a binaural bit sound source according to the present disclosure.

FIG. 5 is a detailed flowchart of a method for controlling an output volume of a binaural bit sound source according to the present disclosure.

FIG. 6 is a diagram illustrating a UI configuration of a sound therapy app using a binaural bit sound source according to the present disclosure.

FIG. 7 is a block diagram illustrating an apparatus for controlling an output volume of a binaural bit sound source according to the present disclosure.

### DETAILED DESCRIPTION OF THE DISCLOSURE

Hereinafter, embodiments of the present disclosure will be described in detail with reference to the attached drawings. In this specification, the same or equivalent components will be provided with the same reference numbers, and description thereof will not be repeated. The suffixes “module” and “unit” used for the components in the following description are assigned or used for convenience of description, and do not inherently have distinct meanings or roles. The suffixes are employed solely for ease of reference and should not be considered to convey unique distinctions in meaning or function. If it is deemed that detailed descriptions of the related art obscure the gist of the embodiments disclosed in this specification, the detailed descriptions will be omitted. It should be understood that the attached drawings are merely to provide better understanding of the embodiments disclosed herein and the technical concepts of the present disclosure are not limited to the attached drawings. Thus, the present disclosure should be construed to encompass all alterations, equivalents, and alternatives within the scope of the concepts and technologies disclosed in the present disclosure.

While terms such as “first,” “second,” and so on may be used to describe various components, but the aforementioned components are not limited by these terms. The above terms are used only to distinguish one component from another.

When a component is mentioned to be “connected” or “coupled” to another component, it may be directly connected or coupled to the other component, but it should be understood that there could also be other components in between. On the other hand, when a component is mentioned to be “directly connected” or “directly coupled” to another component, it should be understood that there are no other components in between.

Unless singular expressions clearly indicate otherwise in context, the singular expressions encompass plural expressions.

In the present disclosure, terms such as “comprises” or “includes” are intended to indicate the presence of features, numbers, steps, operations, components, parts, or combinations thereof as specified in the specification, rather than to preclude the presence or possibility of one or more other features, numbers, steps, operations, components, parts, or combinations thereof.

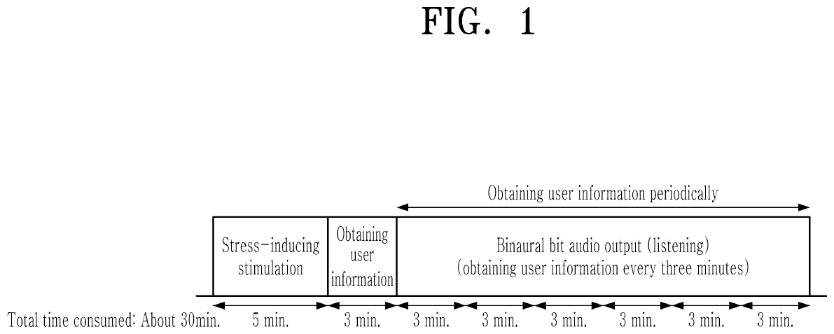

FIG. 1 is a diagram illustrating a protocol of an experiment performed to obtain an important factor for controlling an output of a binaural bit sound source according to the present disclosure.

An experiment used lasts at least 26 minutes, and stress-inducing stimulation is applied to a subject for 5 minutes, user information, e.g., Heart Rate Variability (HRV) in the corresponding experiment is measured for 3 minutes, and then user information is measured every 3 minutes while listening to a binaural beat sound source.

In addition, the above experiment divides a subject group into three groups and sets an output volume of the binaural bit sound source differently. For example, Group A is set to output (listen) a binaural bit sound source at a relatively high volume, Group B is set to output (listen) a binaural bit sound source at a relatively medium volume, and Group C is set to output (listen) a binaural bit sound source at a relatively low volume.

This is an experimental method established under the hypothesis that there is a statistically significant difference in the measurement value (or average thereof) of HRV depending on a volume of the binaural bit sound source; there is a statistically significant difference in the measurement value (or average thereof) of HRV depending on a volume of the binaural bit sound source over time; or there is a statistically significant difference in the measurement value (or average thereof) of HRV per volume of the binaural bit sound source over time.

Various values may be derived from the measurement value of HRV, among which two types of indexes related to the present disclosure, Root Mean Square of Successive Differences (RMSSD) and Logarithm of High-Frequency Power (lnHF), will be described.

RMSSD is an index obtained by averaging the square of a difference between consecutive heart rate intervals (RR intervals) and converting the value to a square root. In other words, it is an index indicating variability by measuring the difference between consecutive beats. RMSSD is an index that reflects the level of parasympathetic nervous system activity (mainly associated with relaxation and stability), with a high RMSSD value indicating a state of relaxation and a low RMSSD value indicating a state of stress or tension. It is mainly used to evaluate stress or to check a state of recovery after exercise. It is also utilized to analyze the fatigue of an athlete or to evaluate the psychological stress and health status of an ordinary person.

lnHF is a log-transformed value of Power Spectral Density (PSD) of HRV measured in a high frequency band. Since HRV in the High-Frequency (HF) band represents parasympathetic nervous system activity, a higher lnHF value means that the parasympathetic nervous system is activated to stay in a relaxed state. On the contrary, a low lnHF may indicate that stress or sympathetic nervous system activation is relatively dominant. lnHF is useful for evaluating autonomic nervous system balance, especially parasympathetic nervous system activity, and is often used to analyze psychological stress, fatigue, psychological health conditions, etc.

Both indexes are associated with parasympathetic activity, and high RMSSD and lnHF refer to a relaxed state, a recovered state, or a healthy autonomic nervous system balance. It is common for two indexes to increase after exercise, meditation, and relaxation activities, and it decreases as stress or fatigue accumulates. These indexes are the data that can be collected in real time, especially on wearable devices, and may be widely used in personal stress management, health tracking, recovery ability evaluation, etc.

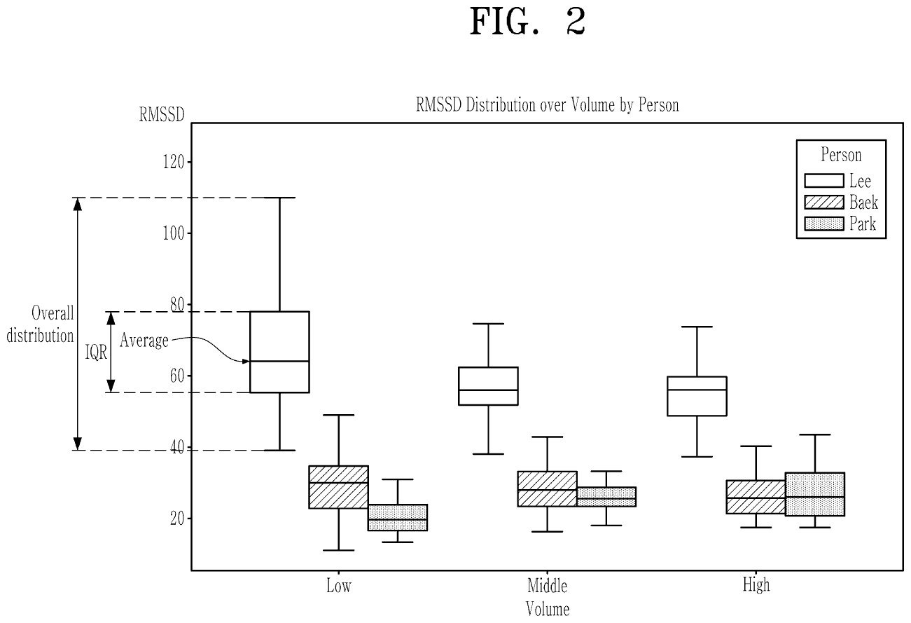

FIG. 2 is a diagram illustrating the distribution of Root Mean Square of Successive Differences (RMSSD) values of subject's Heart Rate Variability (HRV) according to an output volume of a binaural bit sound source obtained experimentally.

For three subjects, an RMSSD measurement value according to an output volume of a binaural bit sound source measured by the experimental method described in FIG. 1 is shown.

A middle part (box width: Interquartile Range (IQR)) of each box plot represents the distribution of 50% of the total data (i.e., data amounting to 25% to 75%), a solid line in the middle represents a center value, and an overall length of the box plot represents the distribution of total data.

It may be seen that RMSSD values of the subjects according to the binaural bit volume are different from individual to individual.

Referring to FIG. 2, when a subject's heart rate is low, a relatively high RMSSD value appears with respect to a low-volume binaural bit sound source. When the heart rate is high, a relatively high RMSSD value appears with respect to and a high-volume binaural bit sound source.

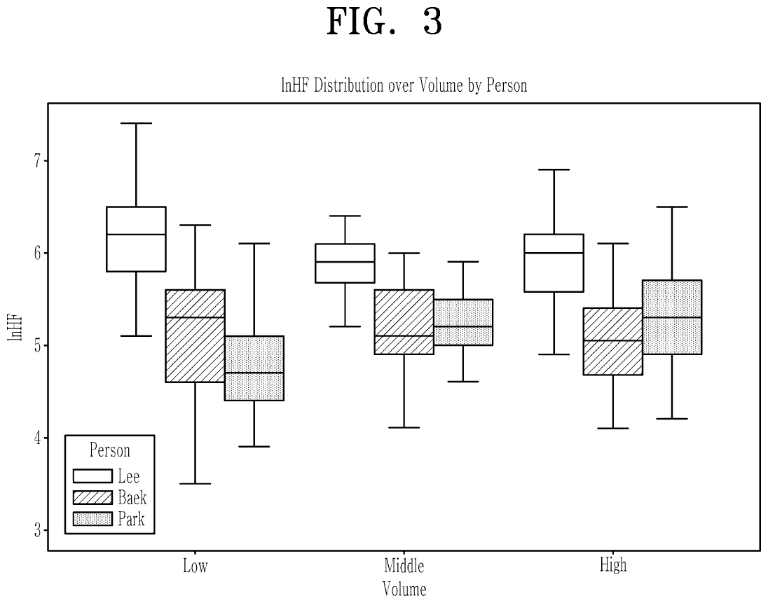

FIG. 3 shows the distribution of Logarithm of High-Frequency Power (lnHF) value of subject's Heart Rate Variability (HRV) according to an output volume of a binaural bit sound source obtained experimentally.

For three subjects, the lnHF measurement value according to an output volume of a binaural bit sound source measured by the experimental method described in FIG. 1 is shown.

A middle part (box width: Interquartile Range (IQR)) of each box plot represents the distribution of 50% of the total data (i.e., data amounting to 25% to 75%), a solid line in the middle represents a center value, and an overall length of the box plot represents the distribution of total data.

It may be seen that the lnHF values of the subjects according to the binaural bit volume are different from individual to individual.

When the subject's heart rate is low, a relatively high lnHF value appears with respect to a low-volume binaural bit sound source. When the heart rate is high, a relatively high lnHF value appears with respect to a high-volume binaural bit sound source.

In conclusion, when the volume of the binaural bit sound source is adjusted according to the HRV, the average of the HRV index values showed a statistically significant difference. If the volume of the binaural bit sound source is personalized, it may be concluded that it is effective in relieving stress.

In addition to RMSSD and lnHF, other indexes are obtained and analyzed in the experiment. Among them, changes in RMSSD and lnHF values among HRV indexes responded faster than other indexes, so it is considered good to look at these two index values when monitoring the effect of the binaural bit sound source.

Looking into the box plot of each subject's HRV index data, it can be seen that relatively high median and maximum values according to the volume of the binaural bit sound source differ from individual to individual. In other words, the volume of the personalized binaural bit sound source according to the HRV is initially outputted (listened) to induce the entry into a relaxed state relatively quickly, and then the volume of the binaural bit sound source different from the initial value is suggested while looking at the trend of the HRV index values.

For example, volume control according to the present disclosure may sequentially adjust a level of volume in order, such as low volume→normal volume→high volume→normal volume→low volume.

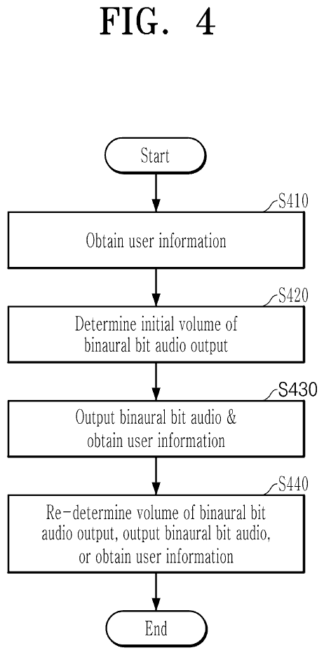

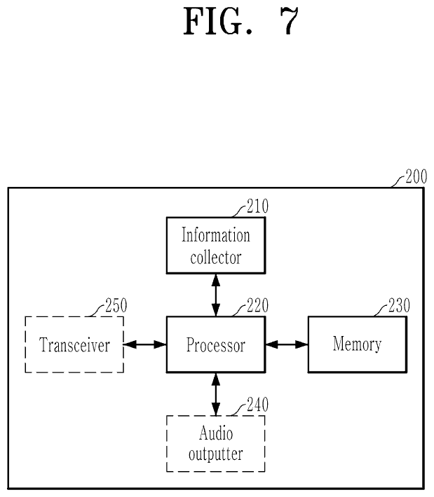

FIG. 4 is a flowchart of a method for controlling an output volume of a binaural bit sound source according to the present disclosure. It may be performed by an apparatus 200 for controlling an output volume of a binaural bit sound source according to FIG. 4, and the apparatus 200 will be described with reference to FIG. 7. Meanwhile, the method according to FIG. 4 may be performed not only by the apparatus 200 but also by a processor 220 of the apparatus 200. Hereinafter, it will be described that the method is performed by the apparatus 200.

The apparatus 200 may be configured to obtain user information (S410). The user information may include biometric information of a user, and may include, for example, HRV information, but the present disclosure is not limited thereto. Specifically, detection of the user information may be performed through a sensor, and the apparatus 200 may obtain user information from the sensor.

The apparatus 200 may be configured to determine an initial volume of a binaural bit (or binaural bit audio data) (S420). The initial volume may be set differently depending on a user. For example, the initial volume may be set differently according to user's personal information, such as user's age or heart rate. The personal information may include a user's blood type, Myers-Briggs Type Indicator (MBTI), height, weight, etc., and the initial volume may be set according to at least one of the user's personal informations.

For example, the initial volume of binaural bit audio data may be set according to the average heart rate range of a user as follows.

TABLE 1

| | Initial |
|---|---|
| Average Heart Rate | Volume Level |
| ~Early 60s per minute | Low |
| ~Late 60s per minute | Middle |
| ~70s and above per minute | High |

If a user-customized initial volume is provided, a user's state (e.g., relaxation state) may be improved in a faster time.

Here, the initial volume level is described as being set to any of the three levels, but this is only an example, and fewer or more volume levels can be used as initial volume levels, which is the same for volume levels to be re-determined or reset.

The apparatus 200 may control binaural bit audio data to be outputted to an audio outputter such as a speaker (S430). In this case, the apparatus 200 may transmit the binaural bit audio data to an audio device such as a wired/wireless earphone, headphone, or wireless speaker of a user without directly outputting the binaural bit audio data to the audio device.

Also, although the binaural bit audio data may be outputted alone, the binaural bit audio data may be outputted from an audio outputter or an audio device together with background audio data. In this case, a volume level of the binaural bit audio data may be set to be lower than a volume level of the background audio data.

The apparatus 200 may obtain user information while the binaural bit audio data is outputted from the audio outputter or the audio device (S430). This is to check whether the binaural bit audio data improves a state (e.g., a relaxed state) of the user.

The apparatus 200 may re-determine an output volume of the binaural bit audio data according to the obtained user information (S440). Then, the apparatus 200 may output the binaural bit audio data at the re-determined output volume (S440). Also, the apparatus 200 may obtain user information while the binaural bit audio data is outputted from the audio outputter or the audio device at the re-determined output volume (S440).

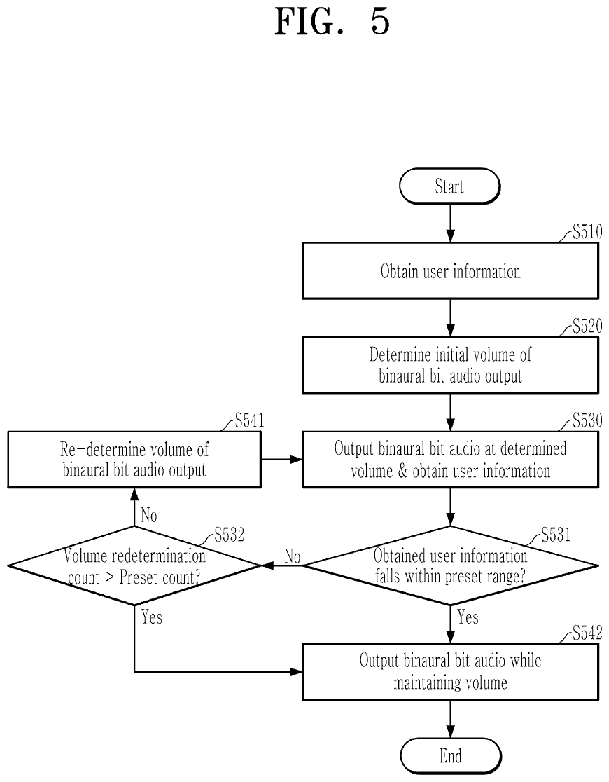

FIG. 5 is a detailed flowchart of a method for controlling an output volume of a binaural bit sound source according to the present disclosure.

It may be performed by the apparatus 200 for controlling an output volume of a binaural bit sound source according to FIG. 5, and the apparatus 200 will be described with reference to FIG. 7. Meanwhile, the method according to FIG. 5 may be performed not only by the apparatus 200 but also by a processor 220 of the apparatus 200. Hereinafter, it will be described that the method is performed by the apparatus 200.

FIG. 5 illustrates FIG. 4 in more detail.

The apparatus 200 may be configured to obtain user information (S510). The user information may include biometric information of a user, and may include, for example, HRV information, but the present disclosure is not limited thereto. Specifically, detection of the user information may be performed through a sensor, and the apparatus 200 may obtain user information from the sensor.

The apparatus 200 may be configured to determine an initial volume of the binaural bit sound source (audio data) (S520).

The apparatus 200 may control binaural bit audio data to be outputted to an audio outputter such as a speaker, and may obtain user information while binaural bit audio data is outputted from an audio outputter or an audio device (S530).

Since S510 to S530 are similar to S410 to S430 of FIG. 4, the description of FIG. 4 will be referred to or cited for contents not described with reference to FIG. 5.

The apparatus 200 may check whether the obtained user information falls within a preset range (S531). This is to determine whether additional control of a volume of the binaural bit audio data is required. For example, the obtained user information may include an RMSSD, and it may be determined whether an obtained RMSSD value falls within a preset range.

When the obtained user information falls within the preset range, the apparatus 200 no longer needs to control the output volume of the binaural bit audio data. Accordingly, the apparatus 200 may be configured to output the binaural bit audio data using a previous output volume (S542). For example, when a time (length) of the output of the binaural bit audio data is preset, the output volume may be maintained until an end timing point. In another embodiment, after S542, when the preset time elapses, the apparatus 200 may perform S530 again.

When the obtained user information does not fall within the preset range, the apparatus 200 may check whether a volume re-determination count exceeds a preset count (e.g., three times) (S532).

As the volume re-determination count does not exceed the preset count, the apparatus 200 may be configured to re-determine the output volume of the binaural bit audio data (S541). In this case, the apparatus 200 may (re)determine the volume according to a preset volume sequence. For example, if the output volume of the binaural bit audio data is set to follow a volume sequence that repeats low→normal→high→normal→low, a re-determined volume (level) may be (re-)determined accordingly.

Then, the apparatus 200 may return to S530 to output the binaural bit audio data at the determined volume and obtain user information while outputting the binaural bit audio data.

As the volume re-determination count exceeds the preset count, the apparatus 200 may be configured to output the binaural bit audio data while maintaining the previously output volume (S542). For example, if the time (length) of the output of the binaural bit audio data is preset, the output volume may be maintained until the end timing point. In another embodiment, if the preset time elapses after S542, the apparatus 200 may perform S530 again.

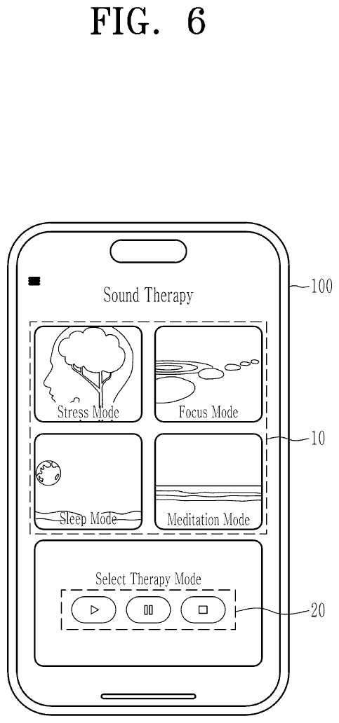

FIG. 6 is a diagram illustrating a User Interface (UI) configuration of a sound therapy app using a binaural bit sound source according to the present disclosure.

FIG. 6 illustrates a UI 100 of a sound therapy app outputted to a display of a user terminal. The sound therapy app provides an interface 10 for selecting a mode (stress relieving mode, concentration mode, sleep mode, and meditation mode) indicating a purpose or usage of binaural bit audio data.

Depending on the purpose or usage of the binaural bit audio data, a frequency of a binaural bit may be changed, and/or an initial volume may be changed.

The sound therapy app provides an interface 20 for controlling a play (output) of the binaural bit audio data. According to an input to the interface 20, the binaural bit audio data may be outputted to an audio outputter or an audio device, or the output may be paused or stopped.

FIG. 7 is a block diagram illustrating an apparatus for controlling an output volume of a binaural bit sound source according to the present disclosure.

In the description of an apparatus 200 related to FIG. 7, it will be described that binaural bits are included in audio data outputted to an audio outputter or an audio device.

The apparatus 200 may include an information collector 210 for obtaining user information, a processor 220 for controlling an output of audio data using the obtained user information, and a memory 240 for storing data for outputting audio data of the processor. The data for an audio data output of the processor may include at least a part of a binaural bit to be provided according to the present disclosure, background audio data to be outputted together with the binaural bit, information on a user-customized initial volume level as shown in Table 1 described above, an output volume sequence of the binaural bit, frequency information on the binaural bit according to a purpose or usage of the binaural bit, information on a “preset range” of S531 of FIG. 5, a “preset number” or volume re-determination count of S532 of FIG. 5, volume (level) information on a most recently used binaural bit, and the like.

In addition, the apparatus 200 may further include an audio outputter 240. The audio outputter 240 has the same configuration as a speaker mounted on or installed on the apparatus 200, and may output audio data including binaural bits as an audio signal.

Also, the apparatus 200 may further include a transceiver 250. The transceiver 250 may be configured to receive data stored in the memory 240 described above from a server or an external device, or to transmit audio data including binaural bits to a wired or wireless audio device. Also, the transceiver 250 may be configured to receive user information to be obtained by the information collector 210 from an external sensor or the like.

Also, the apparatus 200 may further include a display (not shown). The display may be configured to output the user interface 100 as shown in FIG. 6.

The processor 220 may be configured to determine a volume level of an audio output of the binaural bit according to user information obtained at a first timing point, and to output audio data including the binaural bit according to the determined volume level. Here, the audio data may include background audio data. Also, a volume level of the background audio data may be set to be larger than a volume level of the binaural bit.

The user information may include at least one of a biometric signal such as heart rate information of a user, an MBTI type of the user, and age group information of the user. The heart rate information may include HRV or at least one of various indexes that may be derived from the HRV.

The first timing point may include a timing point before an output request (by a user) of audio data including a binaural bit is inputted or detected. In addition, the first timing point may include a timing point ahead of a predetermined time before the audio data including the binaural bit starts to be outputted in a state in which the audio data including the binaural bit is not outputted.

In addition, the processor 220 may be configured to determine a volume level of an audio output of a binaural bit according to user information obtained while the audio data is being outputted at a second timing point, and output audio data including the binaural bit according to the determined volume level.

A variable range of the volume level of the audio output of the binaural bit may be set according to a range in which user information is included among a plurality of preset ranges.

An interval between the first timing point and the second timing point may be set differently depending on user information. Alternatively, an interval between the first timing point and the second timing point may be set depending on user information obtained at the first timing point.

The processor 220 may be configured to determine whether the user information obtained at the second timing point falls within a preset range.

Since the user information obtained at the second timing point does not fall within the preset range, the processor 220 may be configured to set the volume level of the audio output of the binaural bit to a preset value. The preset value may correspond to a volume level according to a preset volume control (change or adjustment) sequence.

As the user information obtained at the second timing point falls within the preset range, the processor 220 may be configured to maintain the volume level of the audio output of the binaural bit.

Meanwhile, the apparatus 200 according to the present disclosure may support not only a single user, but also multiple users at the same time.

Therefore, the information collector 210 may obtain a plurality of user informations. The processor 220 may be configured to output audio data including a binaural bit for each of a plurality of users according to a plurality of the obtained user informations. In this case, a volume level of an audio output of a binaural bit for each of a plurality of users or a variable range of the volume level may be set independently or individually. Accordingly, it is possible to provide optimal binaural bits for a plurality of users.

Even if not described with reference to FIG. 7, the apparatus 200 configured to output audio data including a binaural bit of the present disclosure may perform the operations according to the present disclosure described with reference to FIGS. 4 to 6.

In another aspect of the present disclosure, the above-described proposals or inventive operations may also be provided as code capable of being implemented, performed, or executed by a “computer” (i.e., a comprehensive concept including a system-on-chip (SoC) or a processor (or microprocessor), a computer-readable storage medium including the aforementioned code, or a computer program product. The scope of the present disclosure may be extended to the code, the computer-readable storage medium including the code, or the computer program product.

The exemplary embodiments of the present disclosure have been provided to enable those skilled in the art related to the present disclosure to implement and practice the present disclosure. Although the above description has been provided with reference to the exemplary embodiments of the present disclosure, it will be understood by those skilled in the art that the present disclosure as set forth in the claims below may be modified and varied in various ways. Therefore, the present disclosure is intended to provide the broadest scope consistent with the principles and novel features disclosed herein, rather than being limited to the embodiments disclosed herein.

1. An apparatus, comprising:
an information collector configured to obtain user information; and
a processor configured to control an output of audio data including a binaural bit,
wherein the processor is further configured to determine a volume level of an audio output of the binaural bit according to the user information obtained at a first timing point and output the audio data including the binaural bit according to the volume level determined at the first timing point and
wherein the processor is further configured to determine the volume level of the audio output of the binaural bit according to the user information obtained while the audio data is being outputted at a second timing point and output the audio data including the binaural bit according to the volume level determined at the second timing point.

2. The apparatus of claim 1, wherein the audio data comprises background audio data.

3. The apparatus of claim 2, wherein the volume level of the binaural bit is set smaller than that of the background audio data.

4. The apparatus of claim 1, wherein the user information comprises biometric information of a user.

5. The apparatus of claim 1, wherein the volume level of the audio output of the binaural bit is configured to have a variable range set according to a range among a plurality of preset ranges, to which the user information belongs.

6. The apparatus of claim 1, wherein in response to that the user information obtained at the second timing point fails to fall within a preset range, the processor is configured to set the volume level of the audio output of the binaural bit to a preset value.

7. The apparatus of claim 1, wherein in response to that the user information obtained at the second timing point falls within a preset range, the processor is configured to maintain the volume level of the audio output of the binaural bit.

8. The apparatus of claim 1, wherein the first timing point is set to a timing point before a request for the audio output of the binaural bit based on the user information of a user is inputted.

9. The apparatus of claim 1, wherein an interval between the first timing point and the second timing point is set according to the user information obtained at the first timing point.

10. The apparatus of claim 1, wherein the processor is configured to output the audio data including the binaural bit for a plurality of users based on user information of a plurality of the users and wherein the volume level of the audio output of the binaural bit for each of a plurality of the users or a variable range of the volume level is set independently or individually.

11. A method for outputting audio data including a binaural bit by a device configured to control an output of the audio data including the binaural bit, the method comprising:
determining a volume level of an audio output of the binaural bit according to user information obtained at a first timing point;
outputting the audio data including the binaural bit according to the volume level determined at a first timing point;
determine the volume level of the audio output of the binaural bit according to the user information obtained while the audio data is being outputted at a second timing point; and
outputting the audio data including the binaural bit according to the volume level determined at the second timing point.

12. The method of claim 11, wherein the volume level of the binaural bit is set smaller than that of background audio data included in the audio data.

13. The method of claim 11, wherein the user information comprises biometric information of a user.

14. The method of claim 11, wherein the volume level of the audio output of the binaural bit is configured to have a variable range set according to a range among a plurality of preset ranges, to which the user information belongs.

15. The method of claim 11, comprising setting the volume level of the audio output of the binaural bit to a preset value in response to that the user information obtained at the second timing point fails to fall within a preset range.

16. The method of claim 11, comprising maintaining the volume level of the audio output of the binaural bit in response to that the user information obtained at the second timing point falls within a preset range.

17. The method of claim 11, wherein the first timing point is set to a timing point before a request for the audio output of the binaural bit based on the user information of a user is inputted.

18. The method of claim 11, wherein an interval between the first timing point and the second timing point is set according to the user information obtained at the first timing point.

19. The method of claim 11, comprising;
obtaining user information of a plurality of users; and
outputting the audio data including the binaural bit for a plurality of the users based on the obtained user information,
wherein the volume level of the audio output of the binaural bit for each of a plurality of the users or a variable range of the volume level is set independently or individually.

20. A computer-readable medium for storing a code configured to execute the method according to claim 11 by a computer or a processor.
